(19) United States
(12) Patent Application Publication
(10) Pub. No.: US 2014/0219451 A1
(43) Pub. Date: Aug. 7, 2014

(54) ADAPTIVE SECURITY APPARATUS AND METHOD FOR UPDATING SECURITY PARAMETER

(71) Applicant: MEDIATEK INC., Hsin-Chu (TW)

(72) Inventor: Tao-Sheng Ou, Taoyuan County (TW)

(73) Assignee: MEDIATEK INC., Hsin-Chu (TW)

(21) Appl. No.: 13/761,182

(22) Filed: Feb. 7, 2013

(51) Int. Cl. H04L 9/28

(52) U.S. Cl. CPC H04L 9/28
USPC 380/270

(57) ABSTRACT

An adaptive security apparatus is arranged for updating a security parameter in a database. The adaptive security apparatus includes a message receiver, a data processor, a security processor, and an adaptive parameter processor. The message receiver is arranged for receiving a message. The data processor is arranged for receiving the message from the message receiver and a security parameter from the database. The security processor is arranged for performing a deciphering process and a decoding process according to an output of the data processor. The adaptive parameter processor is arranged for updating the security parameter. Besides, an adaptive security method arranged for adaptively updating a security parameter includes: checking a status of a deciphering process and accordingly generating a checking result; and referring to the checking result to adaptively search a target pattern of the security parameter from a plurality of candidate patterns.

### BACKGROUND

The present invention relates to wireless communications, and more particularly, to an adaptive security apparatus which includes a message receiver, a data processor, a security processor and an adaptive parameter processor, and is arranged for updating a security parameter in a database.

In universal mobile telecommunications system (UMTS) and time division synchronous code division multiple access (TD-SCDMA) system, the cipher parameter changes each time a new message for acknowledged mode (AM)/unacknowledged mode (UM) radio bearer (RB) is received, or when CFN (Connection Frame Number) changes for transparent mode (TM) RB, or when TRHHO (Timing Re-initialized Hard Handover) or change of RNC (Radio Network Controller) occurs in UMTS system, or when a security command is received to start using a new cipher key. In the case that TRHHO or change of RNC occurs in UMTS system, if the resend duration of a response message is too long in the process of TRHHO, the HFN (Hyper Frame Number) used by UMTS terrestrial radio access network (UTRAN) may be different from that used by the user equipment (UE), and this results in the continuous noise during communications. Thus, there is a need for a solution to update the security parameter adaptively.

### SUMMARY

Therefore, one of the objectives of the present invention is to provide an adaptive security method to update the security parameter in a database and related apparatus thereof.

One embodiment of the present invention discloses an adaptive security apparatus, which comprises: a message receiver, a data processor, a security processor, and an adaptive parameter processor. The message receiver is arranged for receiving a message; and the data processor, is coupled to the receiver, arranged for receiving the message from the message receiver and a security parameter from a database; and the security processor is coupled to the data processor, arranged for processing the deciphering and the decoding process; and the adaptive parameter processor is arranged for updating the security parameter.

Another embodiment of the present invention discloses an adaptive security method, arranged for updating the security parameter in a database, wherein the steps of the adaptive security method comprise: utilizing a message receiver for receiving a message; and utilizing a data processor for receiving the message from the message receiver and a security parameter from a database; and utilizing a security processor for processing the deciphering and the decoding process; and utilizing an adaptive parameter processor for updating the security parameter.

Yet another embodiment of the present invention discloses an adaptive security method, arranged for adaptively updating a security parameter. The adaptive security method includes: checking a status of a deciphering process and accordingly generating a checking result; and referring to the checking result to adaptively search a target pattern of the security parameter from a plurality of candidate patterns.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an adaptive security apparatus according to an embodiment of the present invention.

FIG. 2 is a diagram illustrating a security processor in the adaptive security apparatus shown in FIG. 1 according to an embodiment of the present invention.

FIG. 3 is a block diagram illustrating a decipher in the security processor shown in FIG. 2 according to an embodiment of the present invention.

FIG. 4-FIG. 9 are flowcharts illustrating adaptive security methods according to various embodiments of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”, such that the term” “include” and “comprise” mean other elements besides those claimed in claims can also be added.

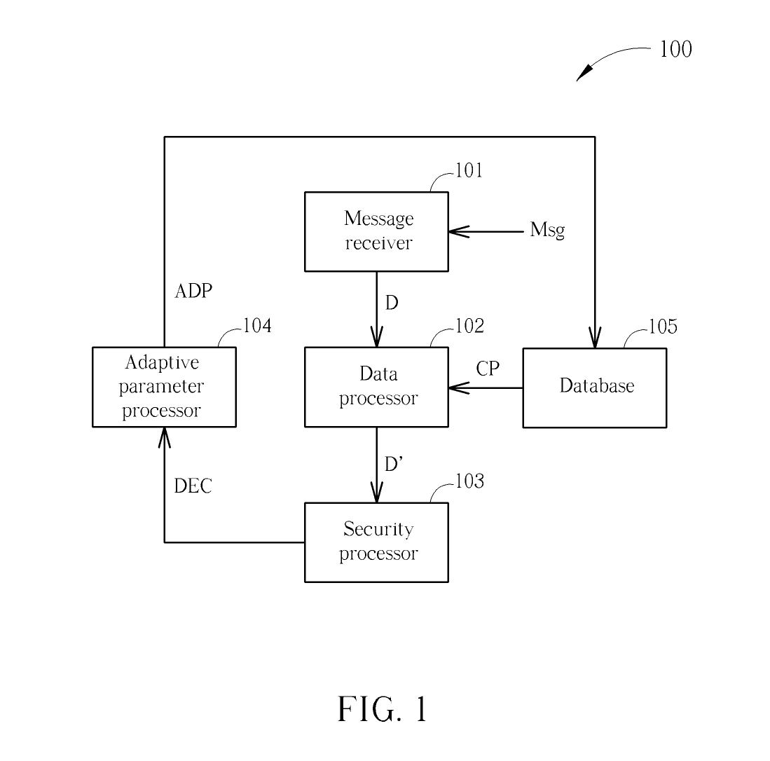

FIG. 1 is a diagram illustrating an adaptive security apparatus according to an embodiment of the present invention. As shown in FIG. 1, the adaptive security apparatus 100 is arranged for updating the security parameter in a database, and includes a message receiver 101, a data processor 102, a security processor 103, and an adaptive parameter processor 104. The message receiver 101 may receive a message Msg, and output a data D to the data processor 102. The data processor 102 may get the data D from the message receiver 101 and receive a cipher parameter (i.e., the security parameter) CP from a database 105, and then output a data D′ including the information of data D and cipher parameter CP to the security processor 103.

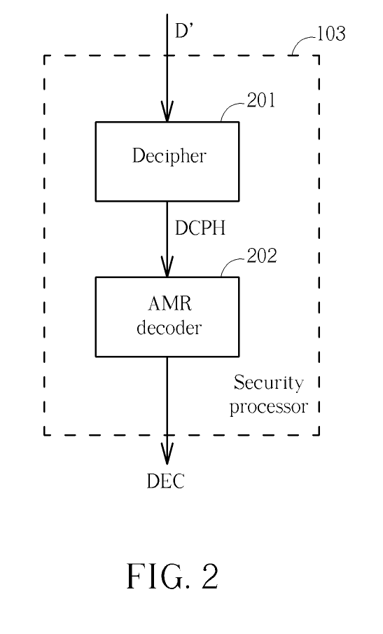

Please refer to FIG. 2, which is a diagram illustrating an embodiment of the security processor 103 shown in FIG. 1. As shown in FIG. 2, the security processor 103 includes a decipher 201 and an adaptive multi-rate (AMR) decoder 202, where the aforementioned data D′ is inputted to the decipher 201. The decipher 201 may output a deciphered result DCPH to the AMR decoder 202, and the AMR decoder 202 may decode the deciphered result DCPH and output a decoded result DEC to the adaptive parameter processor 104. The outputted decoded result DEC may be a normal message or an abnormal message due to decipher failure. Please refer to FIG. 1 again. The adaptive parameter processor 104 may update the adaptive result (e.g., an adaptively updated security parameter) ADP to the database 105.

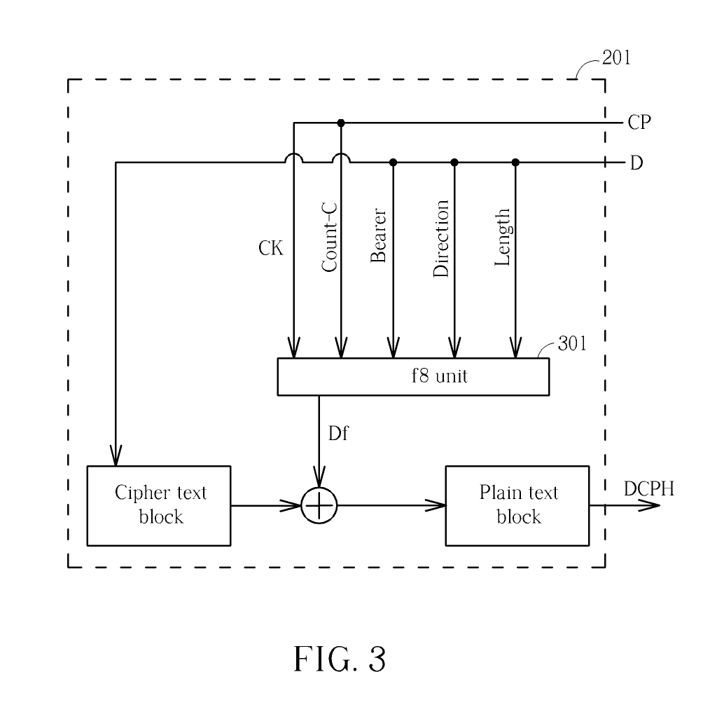

Please refer to FIG. 3, which is a block diagram illustrating an embodiment of the decipher 201 in the security processor 103 shown in FIG. 2. The decipher 201 receives the data D′ including the cipher parameter CP, which contains the Count-C and CK inputted to an f8 unit 301 in the decipher 201, and the data D, which contains the Bearer, Direction, Length, and Cipher text block, wherein the Bearer, Direction, and Length parameters are inputted into the f8 unit 301, and the f8 unit 301 may output the data Df, which is added to the Cipher text block to produce the Plain text block. Next, the decipher 201 outputs the Plain text block as the deciphered result DCPH.

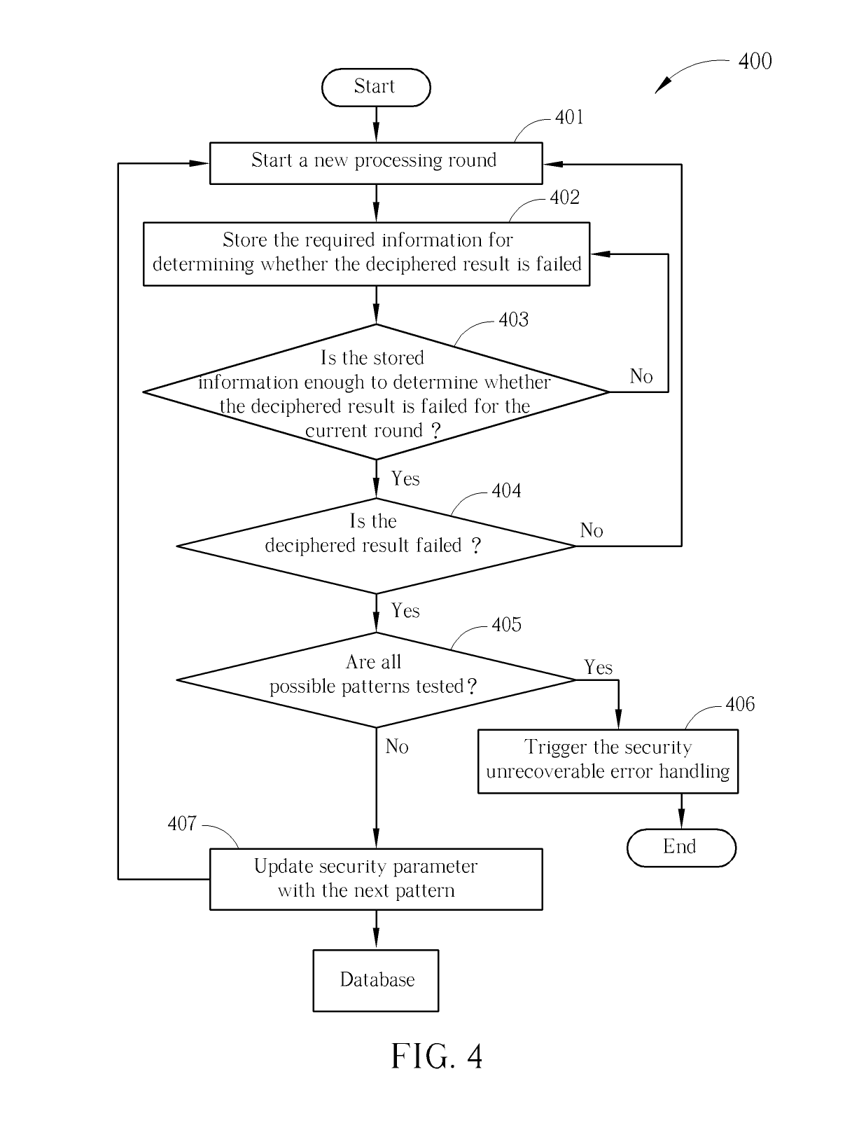

Please refer to FIG. 4, which is a flowchart illustrating an adaptive security method 400 according to a first embodiment of the present invention. The adaptive security method 400 is detailed as below. In the beginning, the decoded result DEC is received, and the flow goes to step 401 to start a new processing round. Step 402 is executed to store the required information (for example, AMR Linear Prediction (LP) coefficients or decoded voice data) from the decoding process for determining whether the deciphered result DCPH is failed for the current round due to decipher failure (that can be seen as determining the status of the deciphering process according to the required information). Step 403 is executed to determine if the stored information is enough to determine whether the deciphered result DCPH is failed for the current round due to decipher failure. If yes, the flow goes to step 404; if no, the flow goes back to step 402. In step 404, the adaptive parameter processor 104 may detect whether the deciphered result DCPH is failed for the current round due to decipher failure, that is, checking a status of a deciphering process and accordingly generating a checking result. If yes, the flow goes to step 405; if no, the flow goes back to step 401. In step 405, the adaptive parameter processor 104 may check if all possible patterns are tested (that is, updating the security parameter by the candidate patterns one by one until the deciphering process succeeds or all of the candidate patterns have been tested). If yes, the flow goes to step 406 to trigger the security unrecoverable error handling, where the error handling could be triggering cell update procedure or triggering local connection release (that is, an error handling process is enabled when the target pattern of the security parameter is not found in the candidate patterns); if no, the flow goes to step 407 to update the security parameter (i.e., the cipher parameter CP) with the next pattern (that can be seen as referring to the checking result to adaptively search a target pattern of the security parameter from a plurality of candidate patterns), that is, vary the parameter, e.g. HFN, for each pattern. If needed, the last pattern could be the original pattern to cope with the possible false alarm in step 404. By way of example, if the current HFN is X, the patterns could be (CK, X−1), (CK, X−2), . . . , (CK, X). Next, the flow goes back to step 401 (that is, checking the status of the deciphering process each time the security parameter is updated by one candidate pattern).

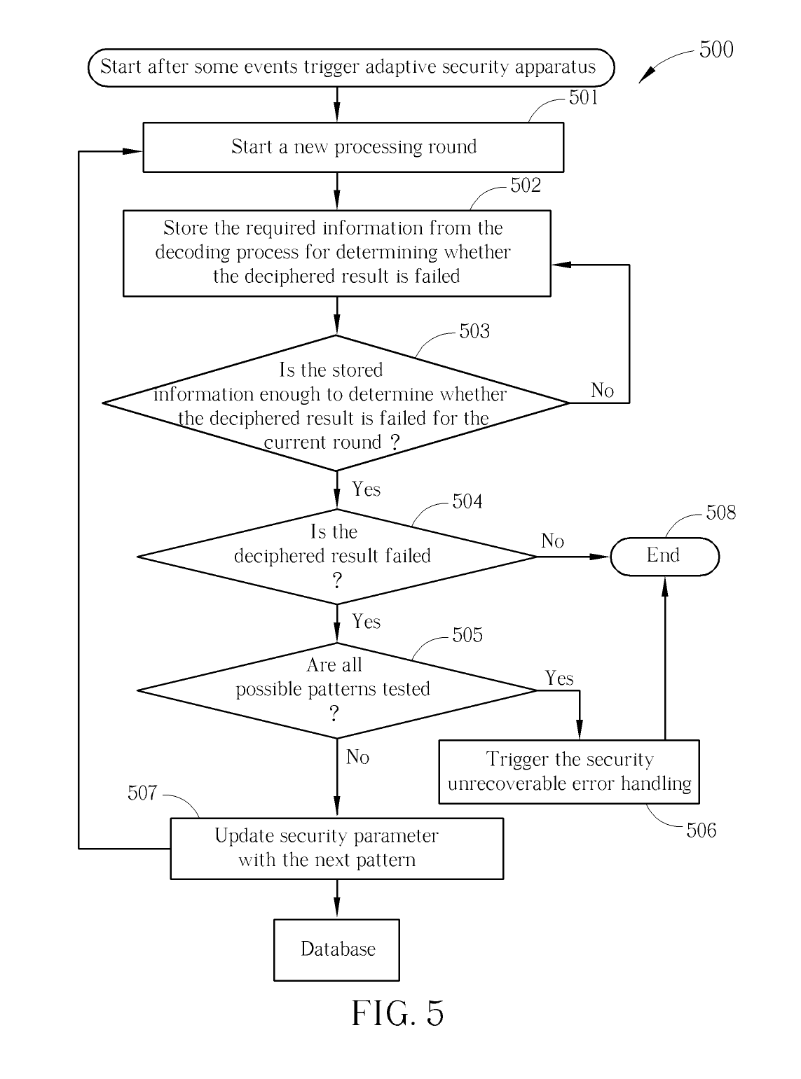

Please refer to FIG. 5, which is a flowchart illustrating an adaptive security method 500 according to a second embodiment of the present invention. The adaptive security method 500 is detailed as below. After some events trigger the adaptive security apparatus 100 (that is, the adaptively updating for a security parameter is operative only when triggered by at least one predetermined event, and the events could be the ones that may cause security parameters unsynchronized between UE and NW (Network)), the flow goes to step 501 to start a new processing round. Next, the flow goes to step 502 to store the required information (for example, AMR Linear Prediction (LP) coefficients or decoded voice data) from the decoding process for determining whether the deciphered result DCPH is failed for the current round due to decipher failure. Next, the flow goes to step 503 to determine if the stored information is enough to determine whether the deciphered result DCPH is failed due to decipher failure. If yes, the flow goes to step 504; if no, the flow goes back to step 502. In step 504, the adaptive parameter processor 104 may detect whether the deciphered result DCPH is failed for the current round (that can be seen as determining the status of the deciphering process according to the required information). If yes, the flow goes to step 505; if no, the flow goes to step 508 to end. In step 505, the adaptive parameter processor 104 may check if all possible patterns are tested (that is, updating the security parameter by the candidate patterns one by one until the deciphering process succeeds or all of the candidate patterns have been tested). If yes, the flow goes to step 506 to trigger the security unrecoverable error handling, where the error handling could be triggering cell update procedure or triggering local connection release (that is, an error handling process is enabled when the target pattern of the security parameter is not found in the candidate patterns); if no, the flow goes to step 507 to update the security parameter (i.e., the cipher parameter CP) in the database with the next pattern (that can be seen as referring to the checking result to adaptively search a target pattern of the security parameter from a plurality of candidate patterns), that is, vary the parameter, e.g. HFN, for each pattern. If needed, the last pattern could be the original pattern to cope with the possible false alarm in step 504. By way of example, if the current HFN is X, the patterns could be (CK, X−1), (CK, X−2), . . . , (CK, X). The flow goes back to step 501 (that is, checking the status of the deciphering process each time the security parameter is updated by one candidate pattern).

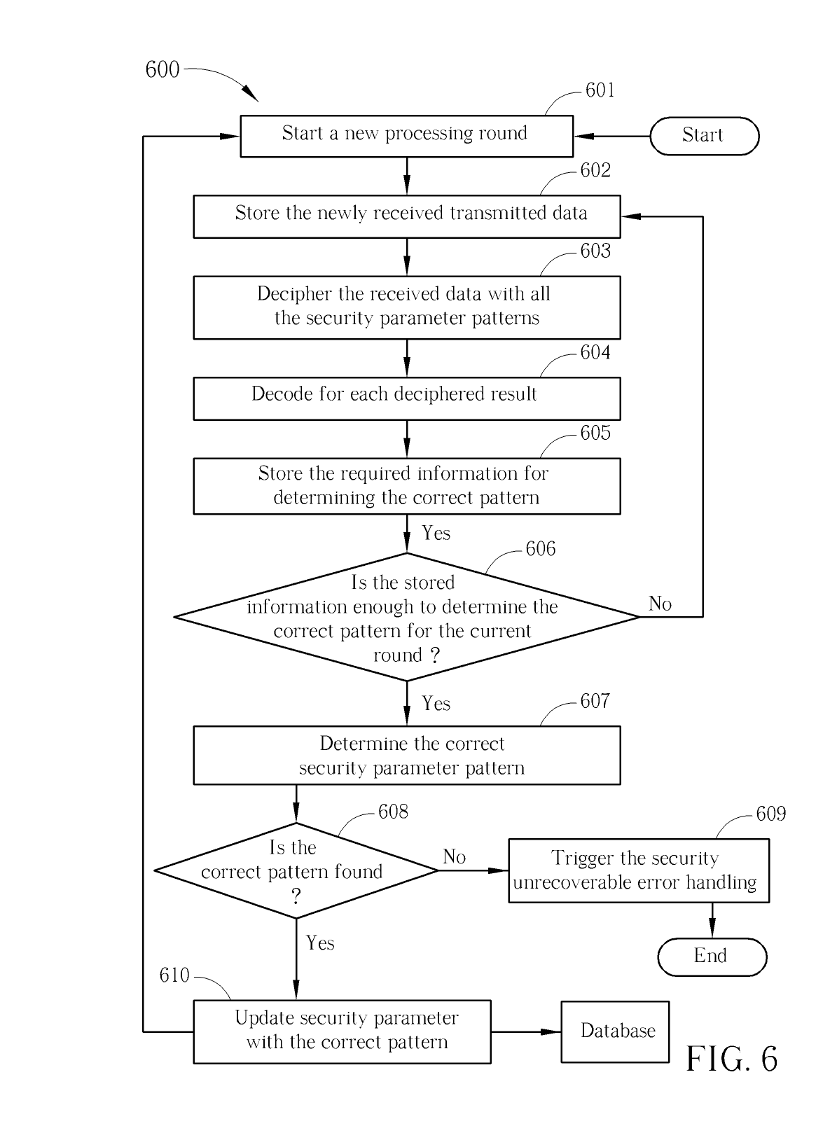

Please refer to FIG. 6, which is a flowchart illustrating an adaptive security method 600 according to a third embodiment of the present invention. The adaptive security method 600 is detailed as below. In the beginning, step 601 starts a new processing round. Next, the flow goes to step 602 to store the newly received transmitted data D, and then goes to step 603, where the decipher 201 deciphers the received data D with all the security parameter patterns. Next, the flow goes to step 604, where the AMR decoder 202 decodes for each deciphered result DCPH. The flow goes to step 605 to store the required information (for example, AMR Linear Prediction (LP) coefficients or decoded voice data) for determining the correct pattern, and then goes to step 606 to determine if the stored information is enough to determine the correct pattern. In one exemplary design, a timer for counting (that is, the process of receiving the required information from the decoding process is stopped when a time period during which the required information is transmitted is expired), for example, 400 ms (i.e., 20 AMR frames) for each pattern or a counter for counting (that is, the process of receiving the required information is stopped when a data amount of the required information transmitted is enough), for example, 20 sets of AMR LP coefficients (i.e., 400 ms) for each pattern can be used to implement this checking step. If yes, the flow goes to step 607; if no, the flow goes back to step 602. In step 607, the adaptive parameter processor 104 may determine the correct security parameter pattern (that is, the status of the deciphering process is not checked until the security parameter is updated by the candidate patterns one by one), and then the flow goes to step 608. In step 608, the adaptive parameter processor 104 checks if the correct pattern is found. If yes, the flow goes to step 610; if no, the flow goes to step 609 to trigger the security unrecoverable error handling, where the error handling could be triggering cell update procedure or triggering local connection release (that is, an error handling process is enabled when the target pattern of the security parameter is not found in the candidate patterns). In step 610, the adaptive parameter processor 104 updates the security parameter (i.e., the cipher parameter CP) with the correct pattern determined in step 607. The flow goes back to step 601.

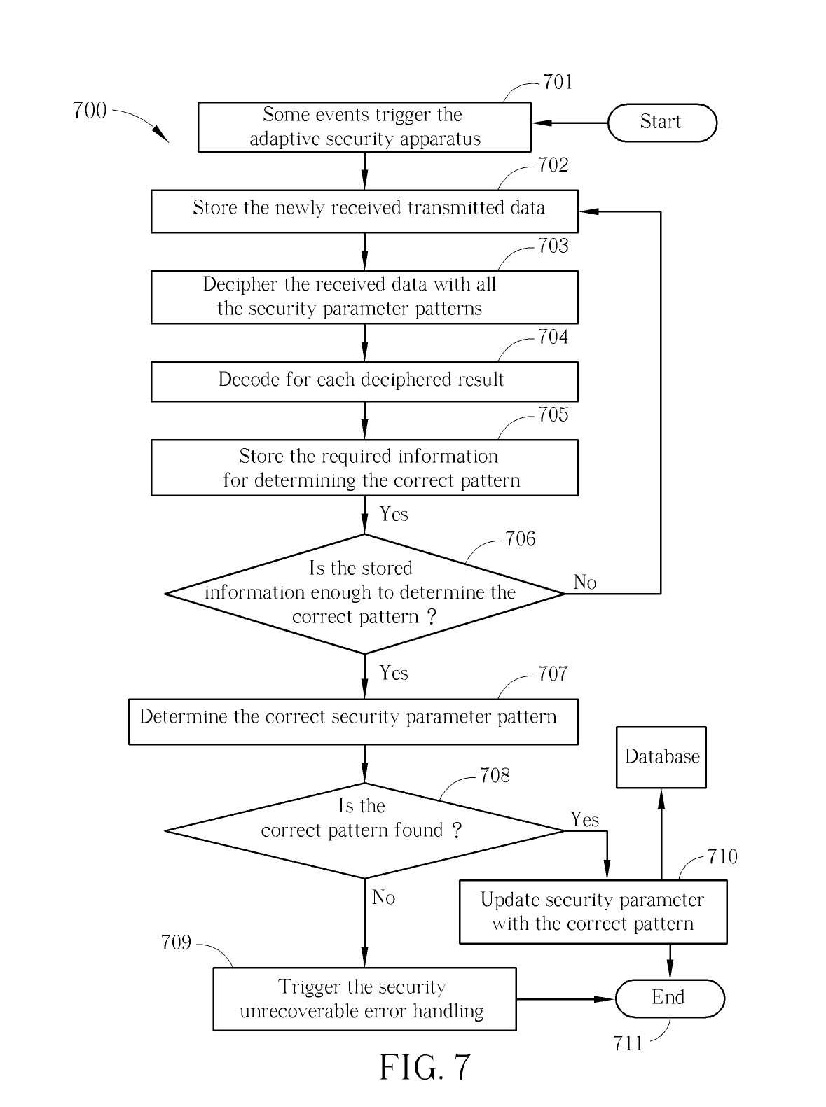

Please refer to FIG. 7, which is a flowchart illustrating an adaptive security method 700 according to a fourth embodiment of the present invention. The adaptive security method 700 is detailed as below. After some events trigger the adaptive security apparatus 100 (the events could be the ones (for example, TRHHO, RB setup establishing first TM RB, etc., that may cause security parameters unsynchronized between UE and NW), the flow goes to step 702 to store the newly received transmitted data D, then goes to step 703, where the decipher 201 deciphers the received data D with all the security parameter patterns. Next, the flow goes to step 704, where the AMR decoder 202 decodes for each deciphered result DCPH. Next, the flow goes to step 705 to store the required information for determining the correct pattern, and then goes to step 706 to determine if the stored information is enough to determine the correct pattern. In one exemplary design, a timer for counting, for example, 400 ms (i.e., 20 AMR frames) for each pattern or a counter for counting, for example, 20 sets of AMR LP coefficients (i.e., 400 ms) for each pattern can be used to implement this checking step. If yes, the flow goes to step 707; if no, the flow goes back to step 702. In step 707, the adaptive parameter processor 104 may determine the correct security parameter pattern (that is, the status of the deciphering process is not checked until the security parameter is updated by the candidate patterns one by one), and then the flow goes to step 708. In step 708, the adaptive parameter processor 104 checks if the correct pattern is found. If yes, the flow goes to step 710; if no, the flow goes to step 709 to trigger the security unrecoverable error handling, where the error handling could be triggering cell update procedure or triggering local connection release (that is, an error handling process is enabled when the target pattern of the security parameter is not found in the candidate patterns). In step 710, the adaptive parameter processor 104 updates the security parameter (i.e., the cipher parameter CP) with the correct pattern determined in step 707. Next, the flow goes to step 711 to end.

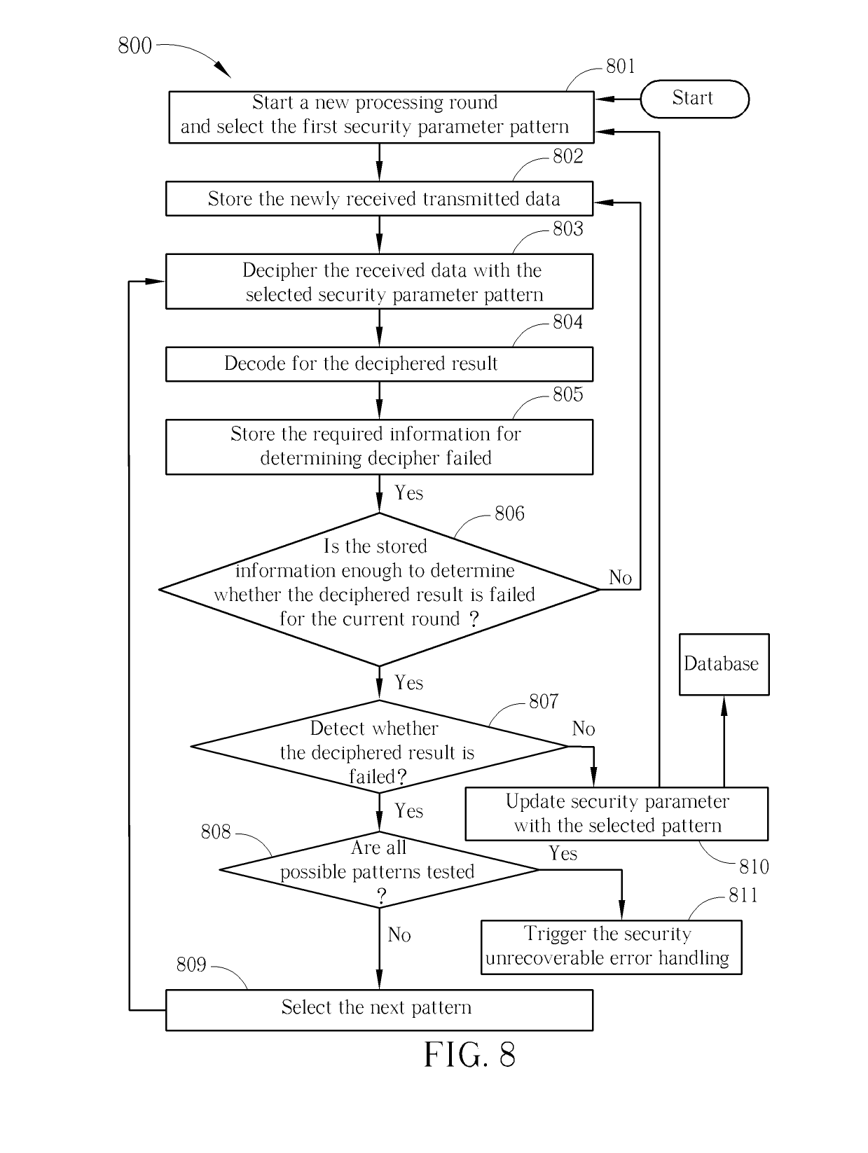

Please refer to FIG. 8, which is a flowchart illustrating an adaptive security method 800 according to a fifth embodiment of the present invention. The adaptive security method 800 is detailed as below. Step 801 starts a new processing round and select the first security parameter pattern, where the first pattern could be the pattern that is currently used (that is, when the adaptively updating for the security parameter is operative, the security parameter is set by one candidate pattern before checking the status of the deciphering process). For example, if the current HFN is X, the first pattern could be (CK, X), and the following patterns could be (CK, X−1), (CK, X−2), and so on. Next, the flow goes to step 802 to store the newly received transmitted data D, and then goes to step 803 where the decipher 201 deciphers the received data D with the selected security parameter pattern. Next, the flow goes to step 804, where the AMR decoder 202 decodes for the deciphered result DCPH. The flow goes to step 805 to store the required information (for example, AMR LP coefficients or decoded voice data) from the decoding process for determining whether the deciphered result DCPH is failed due to decipher failure, and then goes to step 806 to determine if the stored information is enough. If the currently selected security parameter pattern is the first one, this operation may be implemented by a timer to check if the time has been long enough since the information storing for the current round was started (for example, 20 AMR frames), or implemented by a counter to check if the number of samples is large enough (for example, 20 sets of AMR LP coefficients); while if the currently selected pattern is the second or the following ones, the received transmitted data D stored when testing the first pattern is reused. After deciphering and AMR decoding is done, the information should be enough to detect whether the deciphered result DCPH is failed for the current round. If yes, the flow goes to step 807; if no, the flow goes back to step 802. In step 807, the adaptive parameter processor 104 may detect whether the deciphered result DCPH is failed for the current round. If yes, the flow goes to step 808; if no, the flow goes to step 810 to update the security parameter (i.e., the cipher parameter CP) with the selected pattern, and then goes back to step 801. In step 808, the adaptive parameter processor 104 checks if all possible patterns are tested/checked. If yes, the flow goes to step 811 to trigger the security unrecoverable error handling, where the error handling could be triggering cell update procedure or triggering local connection release (that is, an error handling process is enabled when the target pattern of the security parameter is not found in the candidate patterns). If no, the flow goes to step 809 to select the next pattern and goes back to step 803.

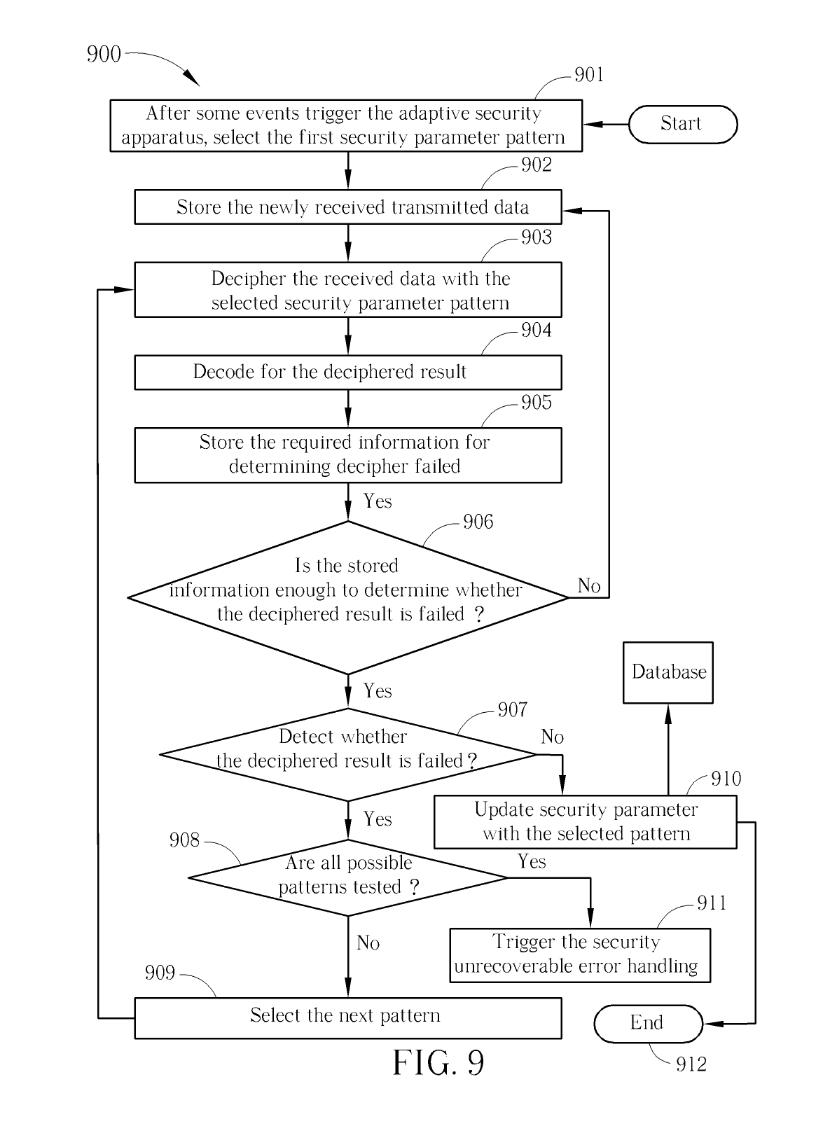

Please refer to FIG. 9, which is a flowchart illustrating an adaptive security method 900 according to a sixth embodiment of the present invention. The adaptive security method 900 is detailed as below. After some events trigger the adaptive security apparatus 100 (that is, the adaptively updating for a security parameter is operative only when triggered by at least one predetermined event, and the events could be the ones that may cause security parameters unsynchronized between UE and NW), the flow goes to step 901 to select the first security parameter pattern, where the first pattern could be the pattern that is currently used (that is, when the adaptively updating for the security parameter is operative, the security parameter is set by one candidate pattern before checking the status of the deciphering process). For example, if the current HFN is X, the first pattern could be (CK, X), and the following patterns could be (CK, X−1), (CK, X−2), and so on. Next, the flow goes to step 902 to store the newly received transmitted data D, and then goes to step 903 where the decipher 201 deciphers the received data D with the selected security parameter pattern. Next, the flow goes to step 904, where the AMR decoder 202 decodes for the deciphered result DCPH. The flow goes to step 905 to store the required information (for example, AMR LP coefficients or decoded voice data) from the decoding process for determining whether the deciphered result DCPH is failed due to decipher failure, and then goes to step 906 to determine if the stored information is enough. If the currently selected security parameter pattern is the first one, this operation may be implemented by a timer to check if the time has been long enough since the information storing was started (for example, 20 AMR frames), or implemented by a counter to check if the number of samples is large enough (for example, 20 sets of AMR LP coefficients); while if the currently selected pattern is the second or the following ones, the received transmitted data D stored when testing the first pattern is reused. After deciphering and AMR decoding is done, the information should be enough to detect whether the deciphered result DCPH is failed. If yes, the flow goes to step 907; if no, the flow goes back to step 902. In step 907, the adaptive parameter processor 104 may detect whether the deciphered result DCPH is failed, that is, checking a status of a deciphering process and accordingly generating a checking result. If yes, the flow goes to step 908; if no, the flow goes to step 910 to update the security parameter (i.e., the cipher parameter CP) with the selected pattern, and goes to step 912 to end. In step 908, the adaptive parameter processor 104 checks if all possible patterns are tested/checked. If yes, the flow goes to step 911 to trigger the security unrecoverable error handling, where the error handling could be triggering cell update procedure or triggering local connection release (that is, an error handling process is enabled when the target pattern of the security parameter is not found in the candidate patterns). If no, the flow goes to step 909 to select the next pattern and goes back to step 903.

In view of above-mentioned embodiments, the continuous noise during communications resulting from that the HFN used by UMTS terrestrial radio access network (UTRAN) may be different from that used by user equipment (UE) can be removed to recover the voice. If not, further procedures may be triggered to avoid the continuous noise.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An adaptive security apparatus, arranged for updating a security parameter in a database, comprising:
a message receiver, arranged for receiving a message;
a data processor, coupled to the message receiver, arranged for receiving the message from the message receiver and the security parameter from the database;
a security processor, coupled to the data processor, arranged for performing a deciphering process and a decoding process according to an output of the data processor; and
an adaptive parameter processor, coupled to the security processor and the message receiver, arranged for updating the security parameter.

2. The adaptive security apparatus of claim 1, wherein the security parameter received by the data processor is a cipher parameter.

3. The adaptive security apparatus of claim 1, wherein the security processor comprises:
a decipher, arranged for performing the deciphering process by deciphering the message received from the message receiver and outputting a deciphered result; and
an adaptive multi-rate (AMR) decoder, arranged for performing the decoding process by decoding the deciphered result from the decipher and outputting a decoded result.

4. The adaptive security apparatus of claim 3, wherein the outputted decoded result is a normal message, or an abnormal message due to the failure of the decipher.

5. The adaptive security apparatus of claim 4, wherein the adaptive parameter processor stores information from the decoding process for determining whether the failure of the decipher occurs.

6. The adaptive security apparatus of claim 4, wherein the adaptive parameter processor updates the security parameter when the failure of the decipher occurs.

7. The adaptive security apparatus of claim 3, wherein the decipher in the security processor comprises:
an f8 unit, arranged for receiving the cipher parameter, data from the data processor, and outputting a processed data.

8. An adaptive security method, arranged for updating a security parameter in a database, the adaptive security method comprising:
utilizing a message receiver for receiving a message;
utilizing a data processor for receiving the security parameter from the database;
utilizing a security processor for processing a deciphering process and a decoding process according to an output of the data processor and the security parameter; and
utilizing an adaptive parameter processor for updating the security parameter.

9. The adaptive security method of claim 8, wherein the security parameter received by the data processor is a cipher parameter.

10. The adaptive security method of claim 8, wherein the adaptive parameter processor updates the security parameter when the decipher process failed.

11. An adaptive security method, arranged for adaptively updating a security parameter, comprising:
checking a status of a deciphering process and accordingly generating a checking result; and
referring to the checking result to adaptively search a target pattern of the security parameter from a plurality of candidate patterns.

12. The adaptive security method of claim 11, further comprising:
decoding a deciphered result of a decipher; and
receiving required information from a decoding process;
determining the status of the deciphering process according to the required information.

13. The adaptive security method of claim 12, wherein the process of receiving the required information from the decoding process is stopped when a time period during which the required information is transmitted is expired.

14. The adaptive security method of claim 12, wherein the process of receiving the required information is stopped when a data amount of the required information transmitted is enough.

15. The adaptive security method of claim 11, further comprising:
checking the status of the deciphering process each time the security parameter is updated by one candidate pattern.

16. The adaptive security method of claim 11, further comprising:
updating the security parameter by the candidate patterns one by one until the deciphering process succeeds or all of the candidate patterns have been tested.

17. The adaptive security method of claim 11, wherein the status of the deciphering process is not checked until the security parameter is updated by the candidate patterns one by one.

18. The adaptive security method of claim 11, wherein the adaptively updating for a security parameter is operative only when triggered by at least one predetermined event.

19. The adaptive security method of claim 11, wherein when the adaptively updating for the security parameter is operative, the security parameter is set by one candidate pattern before checking the status of the deciphering process.

20. The adaptive security method of claim 11, wherein an error handling process is enabled when the target pattern of the security parameter is not found in the candidate patterns.
